(19) United States
(12) Patent Application Publication
(10) Pub. No.: US 2008/0030862 A1
(43) Pub. Date: Feb. 7, 2008

(54) VIEWING TUNNEL

(76) Inventor: Beverly Ann Knapp, Athens (CA)

Correspondence Address: VINCENT PATENT AGENCY, 11-300 EARL GREY DRIVE, SUITE 202, KANATA, ON, K2T 1C1, US

(21) Appl. No.: 11/832,414

(22) Filed: Aug. 1, 2007

Related U.S. Application Data
(60) Provisional application No. 60/835,532, filed on Aug. 4, 2006.

(51) Int. Cl. G02B 27/00

(52) U.S. Cl. 359/601

(57) ABSTRACT

A viewing tunnel for improving the viewability of the display screen of a digital camera under some lighting conditions. The viewing tunnel is a five-panel device that can be used to cradle the digital camera and to shield the display screen from ambient light thereby enhancing an operator's view of the display screen. The five panels can be configured into a in-use configuration forming a four-sided structure (i.e. a tunnel) through which an operator of the camera can view the display screen while permitting the camera to function in the usual manner.

### CROSS-REFERENCE TO RELATED APPLICATIONS

This application claims priority from U.S. Provisional Patent Application Ser. No. 60/835,532, filed Aug. 4, 2006, the entirety of which is incorporated herein by reference.

### FIELD OF INVENTION

The present invention relates to the field of photographic equipment. In particular, to a viewing tunnel for use with a camera having an electronic display.

### BACKGROUND

Digital cameras commonly include an electronic display screen that can be used for composing a scene to be imaged, for reviewing images that have been previously captured, and for providing an operational interface for the camera operator. The electronic display is typically a liquid crystal display (LCD) or other similar display using well-know display technologies.

A common problem experienced by users of digital cameras is that the display screen is difficult to see under certain lighting conditions such as, for example, in bright sun light. The brightness of the screen display is typically limited by factors such as the LCD or other technology used and the need to limit power consumption in battery-powered cameras. Also, the surface of the display screen can be of a reflective nature and in some cameras the display screen cannot be oriented independently of the camera body and/or of the lens element in order to minimize reflection or glare.

What is needed is a mechanism for improving the viewability of the display screen of digital cameras under some lighting conditions.

### SUMMARY OF INVENTION

A viewing tunnel for improving the viewability of the display screen of a digital camera under some lighting conditions. The viewing tunnel is a five-panel device that can be used to cradle the digital camera and to shield the display screen from ambient light thereby enhancing an operator's view of the display screen. The five panels can be configured into a in-use configuration forming a four-sided structure (i.e. a tunnel) having an aperture through which an operator of the camera can view the display screen while permitting the camera to function in the usual manner.

In accordance with one aspect of the present invention, there is provided a viewing tunnel for improving the viewability of the display screen of a digital camera comprising: a first panel; a second panel hingedly attached to the first panel; a third panel hingedly attached to the second panel; a fourth panel hingedly attached to the third panel; a fifth panel hingedly attached to the fourth panel; and a securing mechanism for detachably securing the fifth panel to the first panel; wherein the panels can be folded into an in-use configuration forming a four-sided structure, with the fifth panel secured to the first panel, cradling the digital camera and shielding the display screen from ambient light.

Other aspects and features of the present invention will become apparent to those ordinarily skilled in the art or science to which it pertains upon review of the following description of specific embodiments of the invention in conjunction with the accompanying figures.

### BRIEF DESCRIPTION OF DRAWINGS

The present invention will be described in conjunction with drawings in which:

FIGS. 1A&B are respectively top and bottom views of an exemplary embodiment of a viewing tunnel represented laid-out in a plane.

FIG. 2 is a top view representation of the construction of an exemplary embodiment of the viewing tunnel.

FIG. 3 is an isometric view of an exemplary embodiment of the viewing tunnel folded into an in-use configuration.

FIGS. 4A&B are isometric views of an exemplary embodiment of the viewing tunnel in an in-use configuration cradling a camera.

### DETAILED DESCRIPTION

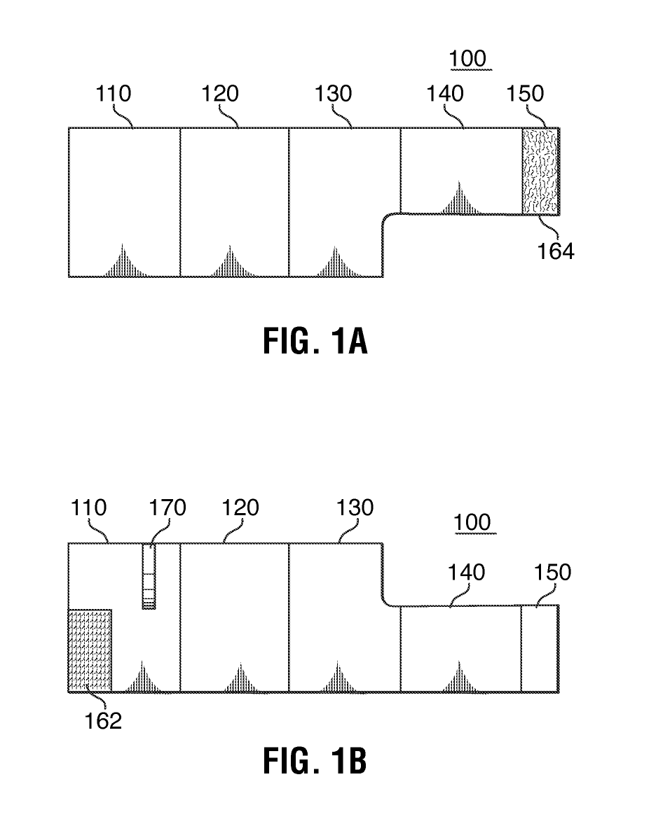

FIGS. 1A&B are, respectively, top and bottom views of an exemplary embodiment of a viewing tunnel 100 represented laid-out in a plane. The viewing tunnel 100 comprises five panels 110, 120, 130, 140, 150 that are hingedly attached one to another. Each panel preferably comprises a core made of a flexible, self-supporting (i.e. semi-rigid) material such as, for example, light to medium weight boxboard. The panels 110, 120, 130, 140, 150 are arranged so that each panel is hingedly attached to each of two adjacent panels with the exception of the first 110 and fifth 150 panels that are hingedly attached only to the second 120 and forth 140 panels respectively. The hinged attachment of the panels 110, 120, 130, 140, 150 to other adjacent panels 110, 120, 130, 140, 150 can be provided by, for example, a fabric that is attached to the panels 110, 120, 130, 140, 150.

FIG. 3 is an isometric view of an exemplary embodiment of the viewing tunnel 100 folded into an in-use configuration. The viewing tunnel 100 can be arranged to form a four-sided structure (i.e. tunnel) by bending the hinged attachments between the panels 110, 120, 130, 140, 150 and securing the fifth panel 150 to the first panel 110. The fifth panel 150 can be detachably secured to the first panel 110 using a detachable securing mechanism 160 such as, for example, a hook-and-loop fastening mechanism (e.g. Velcro®). A first component 162 (e.g. the hooks) of the hook-and-loop fastening mechanism 160 can be attached to the first panel 110 and a second component 164 (e.g. the loops) of the hook-and-loop fastening mechanism 160 can be attached to the fifth panel 150 in an arrangement such that the two components 162, 164 of the hook-and-loop fastening mechanism 160 come into operational engagement when the viewing tunnel 100 is folded into an in-use configuration. In an alternative embodiment (not illustrated) other well known detachable securing mechanisms can be used.

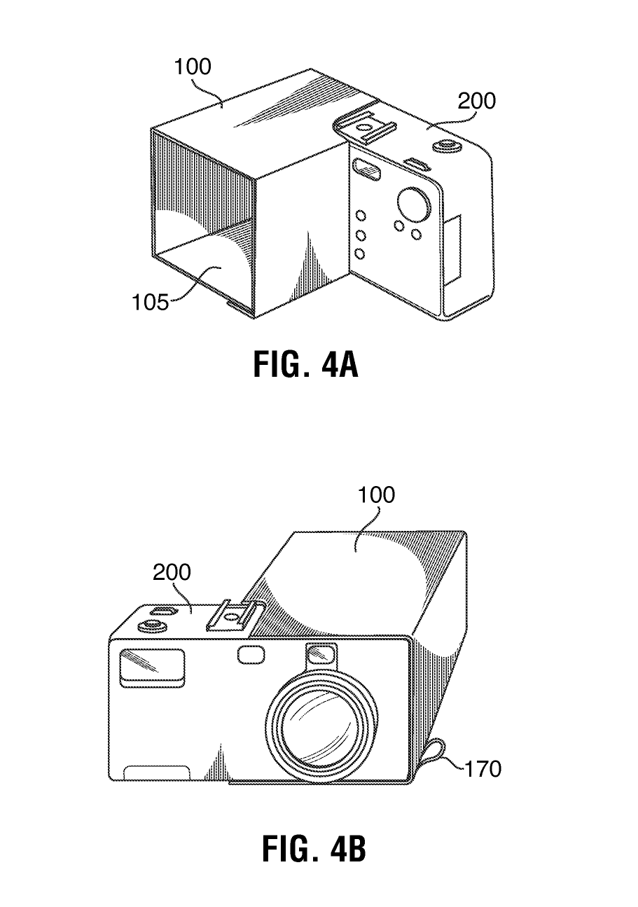

FIGS. 4A&B are isometric views of an exemplary embodiment of the viewing tunnel 100 in an in-use configuration cradling a camera 200. The camera 200 is cradled within the viewing tunnel 100. The portion of the camera 200 including the display screen is contained within the four-sided structure formed by the viewing tunnel 100. The display screen is viewable through an aperture 105 created by the viewing tunnel 100. The viewing tunnel 100 shields the display screen from ambient light thereby enhancing an operator's view of the display screen in some lighting conditions (e.g. by improving contrast or reducing glare). A portion of the camera 200 including, for example, the lens element, a flash lamp and one or more control interfaces (e.g. shutter release, mode setting, aperture and shutter speed controls, menu button, and navigation controls) protrudes from the viewing tunnel 100 in order to provide substantially unobstructed operation of the camera functions. One or more of the panels 110, 120, 130, 140, 150 can have a shape adapted to allowing specific portions (e.g. a surface having a user operable control) of the camera 200 to protrude from the viewing tunnel 100. The shapes of the panels 110, 120, 130, 140, 150 comprising the viewing tunnel 100 can be adapted to a particular make (i.e. brand) and model of camera 200. In an alternative embodiment the shapes of the panels 110, 120, 130, 140, 150 comprising the viewing tunnel 100 can be adapted so that a single embodiment of the viewing tunnel 100 can be used with a variety of similarly sized and configured makes and models of cameras.

The viewing tunnel 100 can optionally include a thumb loop 170 connected to any one of the panels 110, 120, 130, 140, 150 so that the thumb loop 170 is accessible to the operator when the viewing tunnel 100 is cradling a camera 200 in the in-use configuration. The thumb loop 170 is adapted to receiving a digit (e.g. the thumb) of the camera 200 operator's hand. The thumb loop 170 provides for the operator to hold the viewing tunnel 100 cradling the camera 200 in a single hand. The viewing tunnel 100 cradles the camera 200 without the need for any additional attachment mechanism.

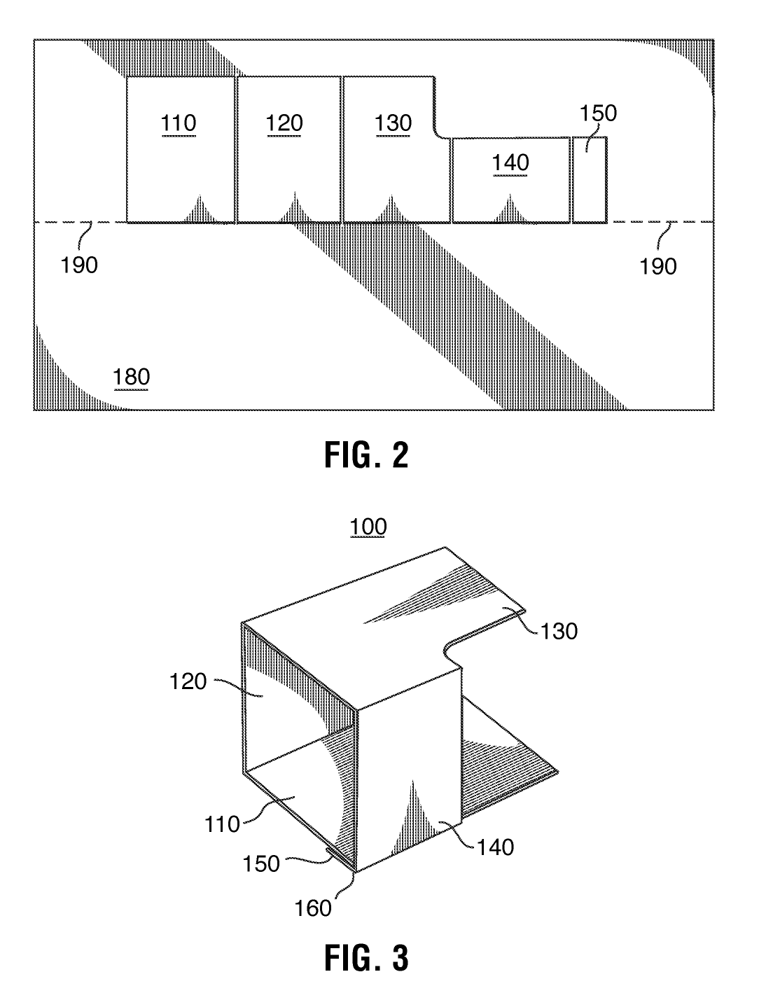

FIG. 2 is a top view representation of the construction of an exemplary embodiment of the viewing tunnel 100. The construction of the viewing tunnel 100 can, for example, begin with cutting each of the five panels 110, 120, 130, 140, 150 from a semi-rigid material (e.g. boxboard). A piece of fabric 180 is then laid-out on a flat surface. The fabric 180 is preferably dark-colored with a non-reflective finish. The fabric 180 is preferably sized so that it can cover both faces of the five panels 110, 120, 130, 140, 150. The fabric 180 is folded in half along a longitudinal axis. The fabric 180 can be pressed to create a fold line 190 in the fabric 180. The fabric 180 is unfolded and an adhesive is applied (e.g. sprayed) on to a surface of the fabric 180. The five panels 110, 120, 130, 140, 150 are applied to the adhesive surface of the fabric 180. The panels 110, 120, 130, 140, 150 are arranged in an orientation that will allow them to be folded into the in-use configuration of the viewing tunnel 100 when construction is completed. For example, the five panels 110, 120, 130, 140, 150 can be laid-out in a linear sequence along the fold line 190 with a gap (e.g. 1/16 inch) between the edges of adjacent panels. The fabric 180 in the gaps between adjacent panels form the hinged attachment between the panels 110, 120, 130, 140, 150. The fabric 180 is re-folded along the fold line 190 so that each of the panels 110, 120, 130, 140, 150 is sandwiched between two layers of the fabric 180. Excess fabric 180 can be trimmed away using the edges of the panels 110, 120, 130, 140, 150 as a guide. Each of two complimentary components of a hook-and-loop fastening mechanism 162, 164 can be attached respectively to one face of the first panel 110 and to the opposite face of the fifth panel 150 so that the two components 162, 164 will come into contact when the viewing tunnel 100 is folded into the in-use configuration. The components of the hook-and-loop fastener 162, 164 can be attached using an adhesive or other well-know attachment mechanisms. Optionally a thumb loop 170 is attached to the first panel 110. The thumb loop 170 can be attached using an adhesive or other well-know attachment mechanisms.

It will be apparent to one skilled in the art that numerous modifications and departures from the specific embodiments described herein may be made without departing from the spirit and scope of the present invention.

1. A viewing tunnel for improving the viewability of the display screen of a digital camera comprising:
a first panel;
a second panel hingedly attached to the first panel;
a third panel hingedly attached to the second panel;
a fourth panel hingedly attached to the third panel;
a fifth panel hingedly attached to the fourth panel; and
a securing mechanism for detachably securing the fifth panel to the first panel;
wherein the panels can be folded into an in-use configuration forming a four-sided structure, with the fifth panel secured to the first panel, cradling the digital camera and shielding the display screen from ambient light.

2. The viewing tunnel of claim 1, wherein the shape of each of the panels is adapted to the shape and configuration of the camera so that a portion of the camera protrudes from the four-sided structure formed by the viewing tunnel providing for substantially unobstructed operation of the camera.

3. The viewing tunnel of claim 1, wherein the shape of each of the panels is adapted to the shape and configuration of a plurality of cameras, including the camera, so that a portion of any one of the cameras protrudes from the four-sided structure formed by the viewing tunnel providing for substantially unobstructed operation of any one of the cameras.

4. The viewing tunnel of claim 1, each of the panels further comprising a semi-rigid core.

5. The viewing tunnel of claim 1, each of the panels further comprising a fabric, the fabric providing for the hinged attachment of the panel to one or more of the other panels.

6. The viewing tunnel of claim 5, wherein the fabric is dark-colored with a non-reflective finish.

7. The viewing tunnel of claim 1, wherein the securing mechanism comprises a two component hook-and-loop fastener, the first component attached to the first panel and the second component attached to the fifth panel.

8. The viewing tunnel of claim 1, further comprising a thumb loop attached to any one of the panels; wherein the thumb loop is adapted to receiving a digit of a camera operator's hand.
